(19) United States
(12) Patent Application Publication
(10) Pub. No.: US 2026/0204619 A1
(43) Pub. Date: Jul. 16, 2026

(54) HIGH VOLTAGE ELECTROLYTES FOR BATTERIES THAT CYCLE LITHIUM IONS

(71) Applicant: GM GLOBAL TECHNOLOGY OPERATIONS LLC, Detroit, MI (US)

(72) Inventors: Umamaheswari VISWANATHAN, Troy, MI (US); Shubha Nageswaran, Sterling Heights, MI (US); Karthikeyan Kaliyappan, LaSalle (CA); Venkataramani Anandan, Cumming, GA (US)

(21) Appl. No.: 19/016,862

(22) Filed: Jan. 10, 2025

(51) Int. Cl. H01M 10/0525; H01M 4/02; H01M 4/505; H01M 4/583; H01M 10/0567; H01M 10/0568; H01M 10/0569

(52) U.S. Cl. CPC H01M 10/0525; H01M 4/505; H01M 4/583; H01M 10/0567; H01M 10/0568; H01M 10/0569; H01M 2004/027; H01M 2004/028; H01M 2300/0037; H01M 2300/0051

(57) ABSTRACT

A battery that cycles lithium ions includes a positive electrode and a liquid electrolyte infiltrating the positive electrode. The electrolyte includes an organic solvent mixture, a primary lithium salt, a fluoroborate salt, a phosphite additive, and a solid electrolyte interphase (SEI)-forming additive in the organic solvent mixture. The organic solvent mixture includes ethylene carbonate and ethyl methyl carbonate. The fluoroborate salt constitutes, by weight, greater than or equal to 0.1% and less than or equal to 2% of the electrolyte. The phosphite additive constitutes, by weight, greater than or equal to 0.01% and less than 3% of the electrolyte. The positive electrode includes an electroactive material comprising a layered lithium-rich and manganese-based transition metal oxide (LRMO).

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to electrolytes including additives for improving high voltage operation.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit certain desirable properties including low viscosity, high ionic conductivity, a wide electrochemical stability window, ability to form a stable ionically conductive solid electrolyte interphase on the surface of the positive electrode and/or the negative electrode, and chemical compatibility with other components of the batteries.

### SUMMARY

A battery that cycles lithium ions, in accordance with one or more embodiments of the present disclosure, comprises a positive electrode and a liquid electrolyte. The positive electrode comprises an electroactive material comprising a layered lithium-rich manganese-based transition metal oxide (LRMO). The liquid electrolyte comprises an organic solvent mixture, a primary lithium salt, a fluoroborate salt, a phosphite additive, and a solid electrolyte interphase (SEI)-forming additive. The organic solvent mixture comprises ethylene carbonate and ethyl methyl carbonate. The fluoroborate salt constitutes, by weight, greater than or equal to 0.1% and less than or equal to 2% of the electrolyte. The phosphite additive constitutes, by weight, greater than or equal to 0.01% and less than 3% of the electrolyte.

The electrolyte may have a viscosity at 25 degrees Celsius of greater than or equal to 3.4 centipoise and less than or equal to 3.7 centipoise.

The electrolyte may have an ionic conductivity of greater than or equal to 7 millisiemens per centimeter.

The fluoroborate salt may comprise lithium tetrafluoroborate (LiBF₄), lithium trifluoro (perfluoro-tert-butyloxyl) borate (LiTFPFB), or a combination thereof.

The fluoroborate salt may constitute, by weight, greater than or equal to 0.5% and less than or equal to 1.5% of the electrolyte.

The phosphite additive may comprise tris (trimethylsilyl) phosphite (TMSPI), triphenyl phosphite (TPPI), or a combination thereof.

The phosphite additive may constitute, by weight, greater than or equal to 0.02% and less than 0.1% of the electrolyte.

The SEI-forming additive may comprise vinylene carbonate.

The SEI-forming additive may constitute, by weight, greater than or equal to 0.5% and less than or equal to 3% of the electrolyte.

The organic solvent mixture may constitute, by weight, greater than or equal to 77% and less than or equal to 91% of the electrolyte.

The ethylene carbonate may constitute, by weight, greater than or equal to 25% and less than or equal to 32% of the electrolyte, and the ethyl methyl carbonate may constitute, by weight, greater than or equal to 52% and less than or equal to 59% of the electrolyte.

The primary lithium salt may comprise lithium hexafluorophosphate (LiPF₆). In such case, the LiPF₆ may be present in the electrolyte at a concentration of greater than or equal to 0.9 Molar and less than or equal to 1.3 Molar.

The LRMO may have a composition represented by the formula Li_{y}MnₓMe₁₋ₓO₂, where 1.1≤y≤1.4, 0.5<x≤1, and Me is a transition metal.

The electrolyte may be substantially free of fluorinated organic solvents.

The electrolyte may be electrochemically stable within a voltage range of greater than or equal to 0 Volts and less than or equal to 4.6 Volts versus Li metal.

A battery that cycles lithium ions, in accordance with one or more embodiments of the present disclosure, comprises a negative electrode, a positive electrode spaced apart from the negative electrode, a separator disposed between the negative electrode and the positive electrode, and an electrolyte infiltrating the positive electrode and configured to provide a medium for the conduction of lithium ions between the negative electrode and the positive electrode. The negative electrode comprises an electroactive negative electrode material and the positive electrode comprises an electroactive positive electrode material. The electrolyte comprises an organic solvent mixture, lithium hexafluorophosphate (LiPF₆), a fluoroborate salt, a phosphite additive, and vinylene carbonate. The organic solvent mixture comprises ethylene carbonate and ethyl methyl carbonate. The ethylene carbonate and the ethyl methyl carbonate constitute, by weight, greater than or equal to 77% and less than or equal to 91% of the electrolyte. The LiPF₆ is present in the electrolyte at a concentration of greater than or equal to 0.9 Molar and less than or equal to 1.3 Molar. The fluoroborate salt comprising lithium tetrafluoroborate (LiBF₄), lithium trifluoro (perfluoro-tert-butyloxyl) borate (LiTFPFB), or a combination thereof. The fluoroborate salt constitutes, by weight, greater than or equal to 0.1% and less than or equal to 2% of the electrolyte. The phosphite additive comprises tris (trimethylsilyl) phosphite (TMSPI), triphenyl phosphite (TPPI), or a combination thereof. The phosphite additive constitutes, by weight, greater than or equal to 0.01% and less than 3% of the electrolyte. The vinylene carbonate constitutes, by weight, greater than or equal to 0.5% and less than or equal to 3% vinylene carbonate.

The fluoroborate salt may comprise LiBF₄, the phosphite additive may comprise TPPI, and the electrolyte may be substantially free of fluorinated organic solvents. In such case, the LiBF₄ may constitute, by weight, greater than or equal to 0.5% and less than or equal to 1.5% of the electrolyte and the phosphite additive may constitute, by weight, greater than or equal to 0.02% and less than 0.1% of the electrolyte.

The electrolyte may have a viscosity at 25 degrees Celsius of greater than or equal to 3.4 centipoise and less than or equal to 3.7 centipoise and an ionic conductivity of greater than or equal to 7 millisiemens per centimeter.

The electroactive negative electrode material may comprise graphite.

The electroactive positive electrode material may comprise a layered lithium-rich manganese-based transition metal oxide (LRMO) having a composition represented by the formula Li_{y}MnₓMe₁₋ₓO₂, where 1.1≤y≤1.4, 0.5<x≤1, and Me is a transition metal.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive and negative electrodes and the porous separator.

FIG. 4 is a plot of Specific Capacity (mAh/g) vs. Cycle Number for cells including an example electrolyte prepared in accordance with embodiments of the present disclosure or a reference electrolyte for purposes of comparison.

In the drawings, reference numbers may be reused to identify similar and/or identical elements.

### DETAILED DESCRIPTION

The presently disclosed electrolytes are formulated for use in batteries that include lithium-rich and manganese-based transition metal oxides (LRMO) as electroactive positive electrode materials, which may operate at relatively high voltages. The electrolytes include an organic solvent mixture that is formulated to provide the electrolytes with relatively low viscosity and high ionic conductivity, at relatively low cost. The low viscosity of the electrolytes may help increase the efficiency of the battery manufacturing process, for example, by significantly reducing the amount of time required to fill the batteries with the electrolyte after assembly of the other components of the battery. In aspects, the organic solvent mixture included in the presently disclosed electrolytes may reduce the filling time of large cell format batteries to about 30 minutes. For comparison, filling a commercial large cell format battery with an electrolyte including an organic solvent mixture of FEC and DEC may take about 8 hours without the use of a vacuum. In addition, the low viscosity of the presently disclosed electrolytes is obtained without the use of expensive fluorinated organic solvents. Furthermore, the presently disclosed electrolytes include a combination of additives that is specifically tailored to provide LRMO-containing batteries with exceptional electrochemical stability at high voltage. Due to the specific combination of additives included in the presently disclosed electrolytes, the total amount of additives in the electrolytes may be minimized, which may help ensure that the electrolytes maintain a desirably low cost, low viscosity, and high ionic conductivity.

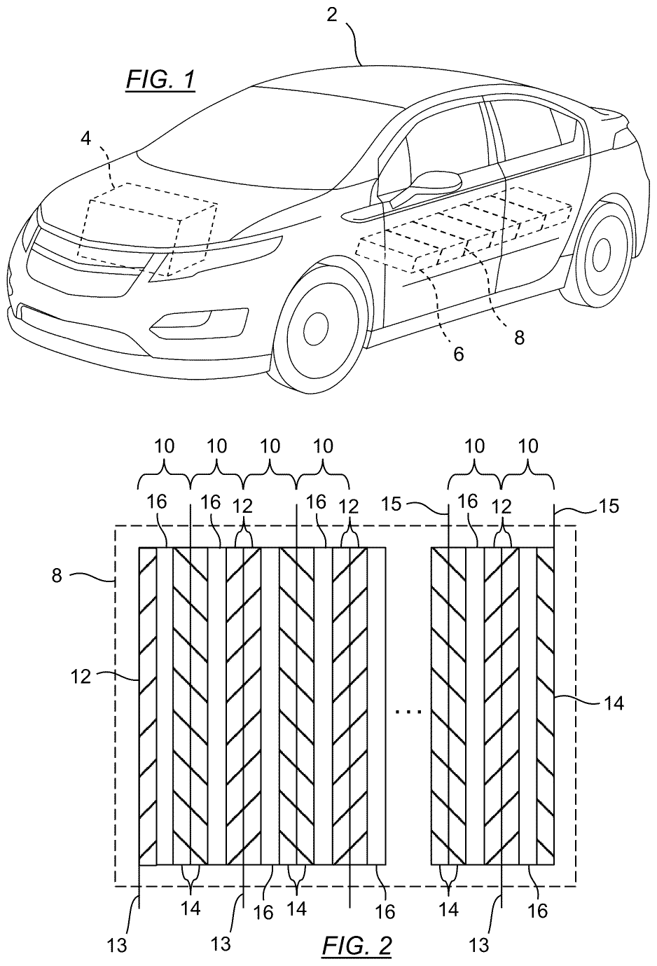

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

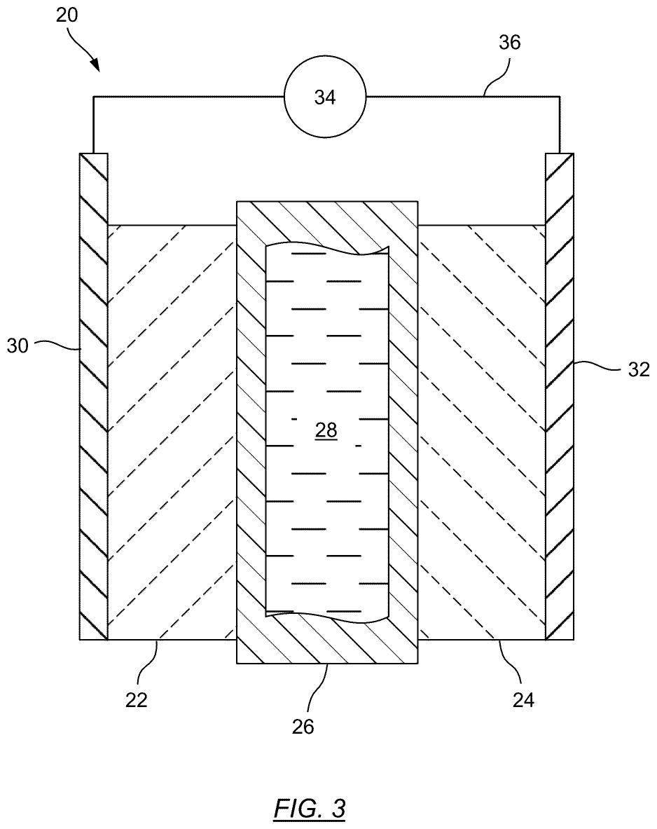

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The electrolyte 28 is ionically conductive and provides a medium for the conduction of lithium ions between the negative electrode 22 and the positive electrode 24. In practice, the electrolyte 28 is a liquid and infiltrates the pores of the positive electrode 24, the separator 26, and optionally the negative electrode 22 (in embodiments where the negative electrode 22 is porous). The electrolyte 28 comprises an organic solvent mixture, a primary lithium salt, a fluoroborate salt, a phosphite additive, and a solid electrolyte interphase (SEI)-forming additive.

The electrolyte 28 is formulated to have relatively low viscosity, which may help improve the electrochemical performance of the battery 20 and also help simplify and/or reduce the time required to assemble the battery 20, for example, by decreasing the amount of time required for the electrolyte 28 to infiltrate the pores of the positive electrode 24, the separator 26, and optionally the negative electrode 22 during the assembly process. In aspects, the electrolyte 28 may have a viscosity at 25 degrees Celsius (° C.) of greater than or equal to 3.4 centipoise (cP) and less than or equal to 5 cP, optionally less than or equal to 4 cP, or optionally less than or equal to 3.7 cP.

The electrolyte 28 is formulated to have high ionic conductivity, which may help provide the battery 20 with exceptional electrochemical performance. For example, the ionic conductivity of the electrolyte 28 may be greater than or equal to 7 millisiemens per centimeter (mS/cm), optionally greater than or equal to 7.5 mS/cm, or optionally greater than or equal to 7.7 mS/cm, and less than or equal to 15 mS/cm, or optionally less than or equal to 8 mS/cm.

The electrolyte 28 is formulated to provide the battery 20 with exceptional electrochemical stability at high voltages, which may help improve the cycle life of the battery 20 without compromising the electrochemical performance thereof. For example, the electrolyte 28 may be electrochemically stable and may not react at high voltages in a way that materially or significantly degrades the ionic conductivity thereof when the electrolyte 28 is held at such high voltages at room temperature for an extended duration, e.g., one week. Herein, a material or significant degradation in ionic conductivity is a reduction in ionic conductivity by an order of magnitude or more. For example, the electrolyte 28 is formulated to be electrochemically stable at voltages of greater than 4.3 V, optionally greater than or equal to 4.4 V, optionally greater than or equal to 4.5 V, or optionally greater than or equal to 4.6 V versus Li⁺/Li.

The organic solvent mixture comprises a mixture nonaqueous aprotic organic solvents and is formulated to provide the electrolyte 28 with low viscosity and high ionic conductivity, at low cost. The organic solvent mixture may constitute, by weight, greater than or equal to 77%, optionally greater than or equal to 80%, and less than or equal to 91%, or optionally less than or equal to 88%, of the electrolyte 28, based on the total weight of the electrolyte 28. In aspects, the organic solvent mixture may constitute, by weight, greater than or equal to 84% and less than or equal to 85% of the electrolyte 28.

The organic solvent mixture comprises ethylene carbonate (EC) and ethyl methyl carbonate (EMC). The volumetric ratio of EC to EMC (EC:EMC) in the electrolyte 28 may be greater than or equal to 20:80 and less than or equal to 40:60. In aspects, the volumetric ratio of EC to EMC in the electrolyte 28 may be about 30:70. The ethylene carbonate may constitute, by weight, greater than or equal to 25% and less than or equal to 32% of the electrolyte 28. The ethyl methyl carbonate may constitute, by weight, greater than or equal to 52% and less than or equal to 59% of the electrolyte 28.

The organic solvent mixture (and the electrolyte 28) may be substantially free of fluorinated organic solvents. For example, the electrolyte 28 may comprise, by weight, less than 5%, optionally less than 3%, optionally less than 1%, optionally less than 0.1%, or optionally less than 0.01% fluorinated organic solvents. Non-limiting examples of fluorinated organic solvents that are preferably excluded from the electrolyte 28 include fluoroethylene carbonate (FEC).

The primary lithium salt is soluble in the organic solvent mixture and provides a passage for lithium ions through the electrolyte 28. The primary lithium salt comprises lithium hexafluorophosphate (LiPF₆). The primary lithium salt may be dissolved in the organic solvent mixture at a concentration of greater than or equal to 0.9 Molar and less than or equal to 1.3 Molar. In aspects, the primary lithium salt may be dissolved in the organic solvent at a concentration of about 1.1 Molar. The primary lithium salt may constitute, by weight, greater than or equal to about 5%, optionally greater than or equal to about 10%, and less than or equal to about 20%, or optionally less than or equal to about 15% of the electrolyte 28.

The fluoroborate salt is formulated to help improve the electrochemical stability of the battery 20 during high voltage operation, and thereby improve the cycle life of the battery 20, without reducing the ionic conductivity of the electrolyte 28. For example, the fluoroborate salt is formulated to have relatively high resistance to hydrolysis, as compared to that of the primary lithium salt, which may help prevent or inhibit the formation of hydrofluoric acid (HF) in the battery 20. In addition, the fluoroborate salt is formulated to participate in formation of a thin cathode electrolyte interphase (CEI) layer on surfaces of the electroactive material of the positive electrode 24 during initial cycling of the battery 20. The CEI layer is electrically insulating and ionically conductive and may help prevent or inhibit chemical degradation of the positive electrode 24 during cycling of the battery 20, for example, by preventing physical contact between the electroactive material of the positive electrode 24 and the electrolyte 28 after initial CEI formation, without inhibiting the transport of lithium ions. It may be desirable to prevent physical contact between the electroactive material of the positive electrode 24 and the electrolyte 28 during cycling of the battery 20, for example, to prevent HF in the electrolyte 28 from reacting with and chemically degrading the electroactive material of the positive electrode 24 and/or to prevent or inhibit oxidation of the components of the electrolyte 28. The fluoroborate salt comprises lithium tetrafluoroborate (LiBF₄), lithium trifluoro (perfluoro-tert-butyloxyl) borate (LiTFPFB), or a combination thereof. The fluoroborate salt may constitute, by weight, greater than or equal to 0.1%, optionally greater than or equal to 0.5%, or optionally greater than or equal to 0.8%, and less than or equal to 2%, optionally less than or equal to 1.5%, or optionally less than or equal to 1.2% of the electrolyte 28. In aspects, the fluoroborate salt may constitute, by weight, about 1% of the electrolyte 28.

The phosphite additive is formulated to complement the function of the fluoroborate salt by helping further improve the electrochemical stability of the battery 20 during high voltage operation. For example, the phosphite additive is formulated to help prevent or inhibit chemical and physical degradation of the electroactive material of the positive electrode 24, for example, by capturing free oxygen in the electrolyte 28, which may be released from the positive electrode 24 during initial cycling of the battery 20. In addition, because the phosphite additive is included in the electrolyte 28 in combination with the fluoroborate salt, the amount of the phosphite additive included in the electrolyte 28 may be kept relatively low, which may help improve the ionic conductivity of the electrolyte 28, as compared to electrolytes that include a phosphite additive but do not include a fluoroborate salt. The phosphite additive comprises tris (trimethylsilyl) phosphite (TMSPI), triphenyl phosphite (TPPI), or a combination thereof. The phosphite additive may be included in the electrolyte 28 in an amount constituting, by weight, greater than or equal to 0.01%, optionally greater than or equal to 0.02%, optionally greater than or equal to 0.1%, optionally greater than or equal to 0.2%, and less than 3%, optionally less than or equal to 2%, optionally less than or equal to 1.5%, optionally less than or equal to 1%, optionally less than or equal to 0.5%, optionally less than or equal to 0.2%, optionally less than or equal to 0.1%, or optionally less than or equal to 0.08% of the electrolyte 28. In aspects, the phosphite additive may constitute, by weight, about 0.05% of the electrolyte 28.

The solid electrolyte interphase (SEI)-forming additive is formulated to participate in formation of an SEI layer on surfaces of the electroactive material of the negative electrode 22 during initial cycling of the battery 20. The SEI layer is electrically insulating and ionically conductive and may help prevent or inhibit chemical degradation of the negative electrode 22 during cycling of the battery 20, for example, by preventing physical contact between the electroactive material of the negative electrode 22 and the electrolyte 28 after SEI formation, without inhibiting the transport of lithium ions. In addition, it may be desirable to prevent physical contact between the electroactive material of the negative electrode 22 and the electrolyte 28 after initial SE formation to help prevent or inhibit reduction of the components of the electrolyte 28. The SEI-forming additive may comprise vinylene carbonate (VC). The SEI-forming additive may constitute, by weight, greater than or equal to 0.5%, optionally greater than or equal to 1%, or optionally greater than or equal to 1.5%, and less than or equal to 3%, or optionally less than or equal to 2.5% of the electrolyte 28. In aspects, the SEI-forming additive may constitute, by weight, about 2% of the electrolyte 28.

The positive electrode 24 is a continuous porous layer disposed on the major surface of the positive electrode current collector 32 and comprises an electroactive material (electroactive positive electrode material), which may be a particulate material and particles of the electroactive positive electrode material may be intermingled with a polymer binder and optionally an electrically conductive material in the positive electrode 24.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. In aspects, the electroactive material of the positive electrode 24 may be a “high-voltage” electroactive material and may have an upper cutoff potential of greater than 4.3 V, optionally greater than or equal to 4.4 V, or optionally greater than or equal to 4.5 V, and less than or equal to 4.6 V versus Li⁺/Li. The electroactive material of the positive electrode 24 may constitute, by weight, greater than or equal to 70%, optionally greater than or equal to 80%, or optionally greater than or equal to 90% and less than or equal to 98%, or optionally less than or equal to 95%, of the positive electrode 24.

The electroactive material of the positive electrode 24 comprises a lithium transition metal oxide. For example, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof).

In aspects, the electroactive material of the positive electrode 24 may comprise a layered lithium-rich and manganese-based transition metal oxide (LRMO). In such case, the electroactive material of the positive electrode 24 may have a composition represented by the formula Li_{y}MnₓMe₁₋ₓO₂, where y is greater than 1, optionally greater than or equal to 1.1, optionally greater than or equal to 1.2, and less than or equal to 1.4, or optionally less than or equal to 1.33, x is greater than 0.5, optionally greater than or equal to 0.6, or optionally greater than or equal to 0.7, and less than 1, optionally less than or equal to 0.9, or optionally less than or equal to 0.8, and Me is a transition metal (e.g., Co, Ni, Fe, Al, V, or a combination thereof). In aspects, Me may comprise Ni and/or Co. For example, in aspects, the electroactive material of the positive electrode 24 may comprise a lithium nickel manganese oxide (LNMO) represented by the formula Li_{1.2}MnₓNi₁₋ₓO₂, where x is greater than 0.5, or optionally greater than or equal to 0.6, and less than 1, or optionally less than or equal to 0.9. In one specific example, the electroactive material of the positive electrode 24 may comprise Li_{1.2}Mn_{0.7}Ni_{0.3}O₂.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to 1%, or optionally greater than or equal to 5%, and less than or equal to 10% of the positive electrode 24.

The optional electrically conductive material is electrochemically inactive and may be included in the positive electrode 24 to provide the positive electrode 24 with electrical conductivity. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to 1%, or optionally greater than or equal to 5% and less than or equal to 10% of the positive electrode 24.

The negative electrode 22 comprises an electroactive material that is formulated to directly participate in the electrochemical reactions that store and release energy from the battery 20 and may be in the form of a continuous porous or nonporous layer of material disposed on a major surface of the negative electrode current collector 30. The electroactive material of the negative electrode 22 (electroactive negative electrode material) may be lithium and/or may be a material that is formulated to store and release lithium ions by undergoing a reversible redox reaction with lithium during charge and discharge of the battery 20. Examples of electroactive negative electrode materials that can store and release lithium include carbon-based materials (e.g., graphite), silicon, silicon-based materials (e.g., alloys of silicon and lithium), silicon oxide (SiOₓ), silicon oxide-based materials (e.g., lithium silicon oxide, LiSiOₓ), lithium oxide-based materials (e.g., lithium titanate), and combinations thereof. Like the electroactive positive electrode material, in aspects, the electroactive negative electrode material may be a particulate material and particles of the electroactive material of the negative electrode 22 may be intermingled with a polymer binder and optionally an electrically conductive material. The same polymer binders and electrically conductive materials described above with respect to the positive electrode 24 may be included in the negative electrode 22 in substantially the same amounts.

The separator 26 is disposed between the negative electrode 22 and the positive electrode 24 and is configured to physically separate and electrically isolate the negative electrode 22 and the positive electrode 24 from each other while permitting lithium ions to pass therethrough. The separator 26 has an open microporous structure and may comprise an organic and/or inorganic material. For example, the separator 26 may comprise a polymer.

The negative electrode current collector 30 and the positive electrode current collector 32 are electrically conductive, electrochemically inactive, and provide an electrical connection between the external circuit 36 and the negative electrode 22 and the positive electrode 24, respectively. The negative electrode current collector 30 and the positive electrode current collector 32 each individually may be made of metal or another appropriate electrically conductive material.

### EXPERIMENTAL

Full coin cells including different electrolyte formulations were assembled and evaluated using galvanostatic charge and discharge protocols. All cells included a negative electrode comprising a mixture of greater than 90 wt. % graphite, carbon black, and a polymer binder and a positive electrode comprising a mixture of greater than 90 wt. % LRMO, carbon black, and PVDF as a polymer binder. Two example electrolytes were prepared in accordance with embodiments of the present disclosure (Example Elect. #1 and #2), and three reference electrolytes were prepared for comparison (Ref. Elect. #3, #4, and #5). The composition of the example electrolytes and reference electrolytes are shown in Table 1 below.

TABLE 1

| | Organic | | | | | Fluori- |
|---|---|---|---|---|---|---|
| | Solvent | | Fluoro- | Phos- | | nated |
| | Mixture | LiPF₆ | borate | phite | | Car- |
| | (vol:vol) | (Molar) | Salt | Additive | VC | bonate |
| Example | EC:EMC | 1.1 | 1 wt. % | 0.2 wt. % | 2 wt. % | none |
| Elect. #1: | (30:70) | | LIBF₄ | TPPI | | |
| Example | EC:EMC | 1.1 | 1 wt. % | 1 wt. % | 2 wt. % | none |
| Elect. #2: | (30:70) | | LIBF₄ | TPPI | | |
| Ref. Elect. | FEC:DEC | 1.2 | none | 3 wt. % | 2 wt. % | none |
| #3 | (20:80) | | | TMSPI | | |
| Ref. Elect. | FEC:DEC | 1.2 | none | none | none | none |
| #4 | (20:80) | | | | | |
| Ref. Elect. | EC:DMC | 1 | none | none | 1 wt. % | 2 wt. % |
| #5 | (30:70) | | | | | FEC |

The measured viscosity and ionic conductivity of the example electrolytes and reference electrolytes are shown in Table 2 below.

TABLE 2

| | Viscosity | Ionic Conductivity |
|---|---|---|
| | (cP) | (mS/cm) |
| Example Elect. #1: | 3.4 | 7.7 |
| Example Elect. #2: | 3.5 | 7.5 |
| Ref. Elect. #3 | 5.3 | 4.7 |
| Ref. Elect. #4 | 4.9 | 5.1 |
| Ref. Elect. #5 | 2.73 | 12 |

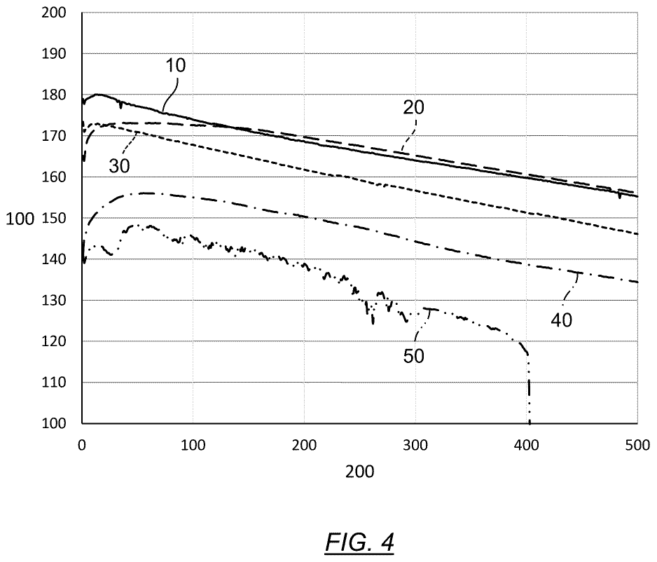

Cells including the example electrolytes and reference electrolytes were galvanostatically charged and discharged at a temperature of about 25° C. at a C/3 rate within a voltage range of 2.0 V and 4.4 V versus Li/Li⁺. FIG. 4 is a plot of Specific Capacity (mAh/g) 100 vs. Cycle Number 200 for cells including Example Elect. #1 (10), Example Elect. #2 (20), Ref. Elect. #3 (30), Ref. Elect. #4 (40), and Ref. Elect. #5 (50).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

As used herein, the phrase at least one of A, B, and C should be construed to mean a logical (A OR B OR C), using a non-exclusive logical OR, and should not be construed to mean “at least one of A, at least one of B, and at least one of C.”

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

What is claimed is:

1. A battery that cycles lithium ions, the battery comprising:
a positive electrode comprising an electroactive material comprising a layered lithium-rich manganese-based transition metal oxide (LRMO); and
a liquid electrolyte comprising:
an organic solvent mixture comprising ethylene carbonate and ethyl methyl carbonate,
a primary lithium salt,
a fluoroborate salt constituting, by weight, greater than or equal to 0.1% and less than or equal to 2% of the electrolyte,
a phosphite additive constituting, by weight, greater than or equal to 0.01% and less than 3% of the electrolyte, and
a solid electrolyte interphase (SEI)-forming additive.

2. The battery of claim 1, wherein the electrolyte has a viscosity at 25 degrees Celsius of greater than or equal to 3.4 centipoise and less than or equal to 3.7 centipoise.

3. The battery of claim 1, wherein the electrolyte has an ionic conductivity of greater than or equal to 7 millisiemens per centimeter.

4. The battery of claim 1, wherein the fluoroborate salt comprises lithium tetrafluoroborate (LiBF₄), lithium trifluoro (perfluoro-tert-butyloxyl) borate (LiTFPFB), or a combination thereof.

5. The battery of claim 4, wherein the fluoroborate salt constitutes, by weight, greater than or equal to 0.5% and less than or equal to 1.5% of the electrolyte.

6. The battery of claim 1, wherein the phosphite additive comprises tris (trimethylsilyl) phosphite (TMSPI), triphenyl phosphite (TPPI), or a combination thereof.

7. The battery of claim 6, wherein the phosphite additive constitutes, by weight, greater than or equal to 0.02% and less than 0.1% of the electrolyte.

8. The battery of claim 1, wherein the SEI-forming additive comprises vinylene carbonate.

9. The battery of claim 8, wherein the SEI-forming additive constitutes, by weight, greater than or equal to 0.5% and less than or equal to 3% of the electrolyte.

10. The battery of claim 1, wherein the organic solvent mixture constitutes, by weight, greater than or equal to 77% and less than or equal to 91% of the electrolyte.

11. The battery of claim 1, wherein the ethylene carbonate constitutes, by weight, greater than or equal to 25% and less than or equal to 32% of the electrolyte, and the ethyl methyl carbonate constitutes, by weight, greater than or equal to 52% and less than or equal to 59% of the electrolyte.

12. The battery of claim 1, wherein the primary lithium salt comprises lithium hexafluorophosphate (LiPF₆), and wherein the LiPF₆ is present in the electrolyte at a concentration of greater than or equal to 0.9 Molar and less than or equal to 1.3 Molar.

13. The battery of claim 1, wherein the LRMO has a composition represented by the formula Li_{y}MnₓMe₁₋ₓO₂, where 1.1≤y≤1.4, 0.5<x≤1, and Me is a transition metal.

14. The battery of claim 1, wherein the electrolyte is substantially free of fluorinated organic solvents.

15. The battery of claim 1, wherein the electrolyte is electrochemically stable within a voltage range of greater than or equal to 0 Volts and less than or equal to 4.6 Volts versus Li metal.

16. A battery that cycles lithium ions, the battery comprising:
a negative electrode comprising an electroactive negative electrode material;
a positive electrode spaced apart from the negative electrode and comprising an electroactive positive electrode material;
a separator disposed between the negative electrode and the positive electrode; and
an electrolyte infiltrating the positive electrode and configured to provide a medium for the conduction of lithium ions between the negative electrode and the positive electrode, the electrolyte comprising:
an organic solvent mixture comprising ethylene carbonate and ethyl methyl carbonate, the ethylene carbonate and ethyl methyl carbonate constituting, by weight, greater than or equal to 77% and less than or equal to 91% of the electrolyte,
lithium hexafluorophosphate (LiPF₆) at a concentration of greater than or equal to 0.9 Molar and less than or equal to 1.3 Molar,
a fluoroborate salt comprising lithium tetrafluoroborate (LiBF₄), lithium trifluoro (perfluoro-tert-butyloxyl) borate (LiTFPFB), or a combination thereof, the fluoroborate salt constituting, by weight, greater than or equal to 0.1% and less than or equal to 2% of the electrolyte,
a phosphite additive comprises tris (trimethylsilyl) phosphite (TMSPI), triphenyl phosphite (TPPI), or a combination thereof, the phosphite additive constituting, by weight, greater than or equal to 0.01% and less than 3% of the electrolyte, and
by weight, greater than or equal to 0.5% and less than or equal to 3% vinylene carbonate.

17. The battery of claim 16, wherein the fluoroborate salt comprises LiBF₄, the LiBF₄ constitutes, by weight, greater than or equal to 0.5% and less than or equal to 1.5% of the electrolyte, the phosphite additive comprises TPPI, the TPPI constitutes, by weight, greater than or equal to 0.02% and less than 0.1% of the electrolyte, and the electrolyte is substantially free of fluorinated organic solvents.

18. The battery of claim 17, wherein the electrolyte has a viscosity at 25 degrees Celsius of greater than or equal to 3.4 centipoise and less than or equal to 3.7 centipoise and an ionic conductivity of greater than or equal to 7 millisiemens per centimeter.

19. The battery of claim 16, wherein the electroactive negative electrode material comprises graphite.

20. The battery of claim 16, wherein the electroactive positive electrode material comprises a layered lithium-rich manganese-based transition metal oxide (LRMO) having a composition represented by the formula Li_{y}MnₓMe₁₋ₓO₂, where 1.1≤y≤1.4, 0.5<x≤1, and Me is a transition metal.
